(19) United States
(12) Patent Application Publication
(10) Pub. No.: US 2015/0089217 A1
(43) Pub. Date: Mar. 26, 2015

(54) Method and System for Data Protection

(71) Applicants: Joseph Max Romanik, Pikesville, MD (US); Christopher Scott Webster, Baltimore, MD (US)

(72) Inventors: Joseph Max Romanik, Pikesville, MD (US); Christopher Scott Webster, Baltimore, MD (US)

(73) Assignee: Secourier, LLC, Thornton, CO (US)

(21) Appl. No.: 14/494,554

(22) Filed: Sep. 23, 2014

Related U.S. Application Data
(60) Provisional application No. 61/882,217, filed on Sep. 25, 2013.

(51) Int. Cl. G06F 21/60; H04W 12/06; H04L 29/06

(52) U.S. Cl. CPC G06F 21/602; H04L 63/0823; H04L 63/0442; H04W 12/06
USPC 713/156; 713/161

(57) ABSTRACT

The present disclosure provides a way for an enciphering party to protect data by ciphering the data, and establishing conditions upon which that data can be deciphered (or accessed) by a deciphering party, without requiring the enciphering party or the deciphering party to share a cipher key, or any other information that in-and-of-itself may be used to decipher the transmitted data; without requiring a System to store the cipher key, or any information that, in isolation, may be used to produce the key; or without requiring that the enciphering party share private data, in any form, with the System.

### CROSS-REFERENCE TO RELATED APPLICATIONS

This application claims the priority benefit of U.S. Provisional Patent Application No. 61/882,217, filed on Sep. 25, 2013, in the United States Patent & Trademark Office, the disclosure of which is incorporated herein by reference.

### BACKGROUND

1. Field

The present disclosure relates to a method and system for protecting data. More particularly, the present disclosure relates to a method and system for protecting and securing data to be stored or shared.

2. Description of Related Art

The theft and misuse of sensitive data may have a catastrophic effect on an individual or organization. To date, the vast majority of time and effort dedicated to protecting data and files has been focused on the use of various encryption technologies. These efforts are aimed at obscuring and encrypting data. Generally, current solutions take the following form: a pool of data is encrypted using a key or set of keys. Then those keys, or some derivation of them, are distributed to the individuals or organizations that are authorized to access the data.

Unauthorized individuals who wish to access data protected in this way have several options—steal a key or reverse engineer a key. Once a data thief has stolen a key, he or she has access to everything encrypted with that key. As the number of keys issued increases, so does the likelihood that one of them will be stolen or misappropriated. Further, in traditional systems, keys are stored in large banks of keys, which are protected with the same insufficient methods that are used to protect the data.

Moreover, most file protection solutions do not allow for the roles of administrator and user to be adequately separated. In a truly secure environment administrators function as gatekeepers to the system—but they themselves never have access to the protected content. For example, if an organization's I/T professionals have access to all of the “protected” data, it is not really protected at all. Moreover, the users—the individuals generating the content—need to be able to put controls in place to determine by whom, when, and how their content is accessed.

In view of the foregoing, a need exists for a more secure way of transmitting and granting access to electronic information. Accordingly, the present invention has been developed in view of the foregoing and to overcome the deficiencies of the prior art.

### SUMMARY

The present disclosure provides a way for an enciphering party to protect data to be stored or transmitted by ciphering the data, and establishing conditions upon which that data can be deciphered (or accessed) by a deciphering party, without requiring the enciphering party or the deciphering party to share a cipher key, or any other information that in-and-of-itself may be used to decipher the transmitted data; without requiring a System to store the cipher key, or any information that, in isolation, may be used to produce the key; or without requiring that the enciphering party share private data, in any form, with the System.

According to example embodiments, the present disclosure may provide a system and method for protecting data, in which an enciphering party sets Shields to be satisfied by a deciphering party; a server generates and transmits a Key Core to the enciphering party; and the enciphering party generates a Cipher Key based on the received Key Core, enciphers the data to be protected using the Cipher Key, builds a Cipher Package including the protected data, and transmits the Cipher Package to the a deciphering party.

According to example embodiments, the present disclosure may provide a method for parameter-based key catalyst management, the method including: receiving, from a first terminal, at least one parameter establishing conditions for deciphering data by a second terminal, the at least one parameter being a verifiable value; transmitting a key catalyst to the first terminal, such that the key catalyst is used in generating a cipher key for enciphering data by the first terminal; verifying whether the conditions established by the at least one parameter are satisfied by the second terminal; and releasing the key catalyst to the second terminal only when the established conditions are satisfied by the second terminal, thereby enabling the second terminal to independently generate the cipher key to decipher the enciphered data.

According to example embodiments, the present disclosure may provide a method for a method for parameter-based key management, the method including: receiving at least one parameter from a terminal, such that the at least one parameter establishes a condition upon which enciphered data is deciphered; transmitting a key catalyst to the terminal in response to the received at least one parameter, the key catalyst being used by the terminal to generate a cipher key that enciphers data, and the enciphered data being stored without the cipher key being shared with another terminal; receiving a request to access the enciphered data from the terminal at a later time, and determining whether the established condition is satisfied by the terminal by comparing an input from the terminal with the at least one parameter; and releasing the key catalyst to the terminal only when the input from the terminal and the at least one parameter are identical.

As such, the deciphering party may access the protected data only when the deciphering party satisfies the Shields that were set by the enciphering party. Thus, data may be shared between the enciphering party and the deciphering party without the server ever having access to the protected data.

### BRIEF DESCRIPTION OF THE DRAWINGS

FIG. 1 illustrates a general implementation of the System, according to example embodiments of the present disclosure.

FIG. 2 illustrates a method of setting Shields, according to example embodiments of the present disclosure.

FIG. 3 illustrates a method of generating a cipher key, according to example embodiments of the present disclosure.

FIG. 4 illustrates a method of generating and sharing a Cipher Package, according to example embodiments of the present disclosure.

FIG. 5 illustrates a method of requesting access to protected data, according to example embodiments of the present disclosure.

FIG. 6 illustrates a method of deciphering data, according to example embodiments of the present disclosure.

FIG. 7 illustrates a method of protecting data and deciphering the protected data, according to example embodiments of the present disclosure.

### DETAILED DESCRIPTION

As will be seen from the disclosure herein, various systems and methods are provided for improvements upon protecting data. For example, in some embodiments, the protected data may be transferred between computers over the Internet or an Intranet. In other embodiments, the protected data may be stored on a computer, e.g., a hard drive. Further, certain embodiments of the present disclosure include methods and systems of setting Shields, which will be discussed later in the present disclosure, for securely transferring and storing data.

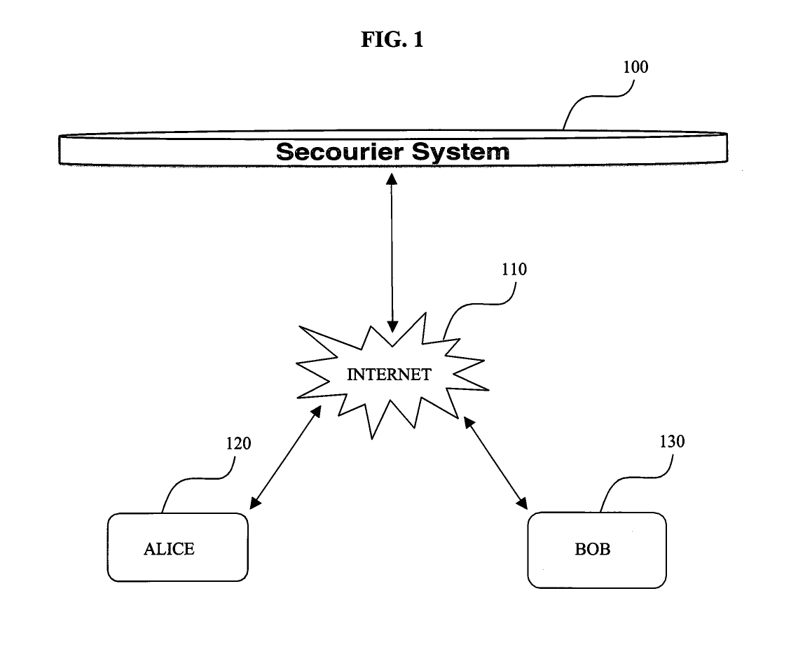

FIG. 1 illustrates a general implementation of the System, according to example embodiments of the present disclosure.

Referring to FIG. 1, the present disclosure describes an example method and system of organizing communication between parties, storing certain communications, and performing basic calculations on certain pieces of stored communications. As such, the present disclosure may include a System 100, which uses the Internet 110 as the communications medium for communications between the communicating parties and the System. For example, the parties desiring to securely share data between themselves include Alice 120 and Bob 130. Alice 120 and Bob 130 may each represent a computer or computing environment upon which electronic information or data to be protected is stored. Both Alice 120 and Bob 130 include at least one processing device to implement the methods discussed herein.

Alice 120 and Bob 130 may each represent both the enciphering party and the deciphering party at different times. For example, Alice 120 may encipher and transmit data to Bob 130 at time t0 and Bob 130 may receive and decipher the transmitted data at time t1. However, Bob 130 may later encipher and transmit data to Alice 120 at time t2 and Alice 120 may receive and decipher the data at time t3. In this example, t0<t1<t2<t3. As another example, Alice 120 may encipher and store data at time t4 and Alice 120 may later decipher the stored and protected data at time t5. In this example, t4<t5.

However, for ease of understanding, in FIGS. 1-7, Alice 120 may represent a computer upon which data to be protected is stored, and Bob 130 may represent a computer, which will receive, store, and decrypt the protected data transmitted by Alice 120, if certain conditions are satisfied. The use of the names Alice and Bob are exemplary and are used simply to facilitate and add clarity to the discussion in the present disclosure. Again, as discussed above, the present disclosure is not limited to Alice 120 enciphering and transmitting data to Bob 130.

Further, the System 100 may include a computer system with digital storage. For example, the System 100 may include a centralized database, which facilitates the data protection process set forth hereinafter.

The present disclosure provides a way for Alice 120 to protect her data by ciphering it, and establish conditions upon which that data can be deciphered (accessed) by Bob 130, without requiring Alice 120 or Bob 130 to share a cipher key, or any other information that in-and-of-itself may be used to decipher the data; without requiring the System 100 to store the cipher key, or any information that, in isolation, can be used to produce the key; or without requiring that Alice 120 share her private data, in any form, with the System 100.

As such, in accordance with example embodiments of the present disclosure, even if the protected data were intercepted during transmission by Alice 120 and reconstituted or reconstructed, the data is still encrypted, unreadable, and useless to a hacker, for example.

To accomplish the secure protection of data, the systems and methods of the present disclosure may include the following steps:
1. Alice 120 sets the conditions (hereinafter referred to as Shields) upon which the data may be deciphered by Bob 130;
2. Alice 120 generates the cipher key and enciphers the data;
3. Alice 120 builds a Cipher Package and transmits it to Bob 130;
4. Bob 130 requests access to the data;
5. Bob 130 satisfies the Shields required to access the data; and
6. Bob 130 deciphers (accesses) the data.

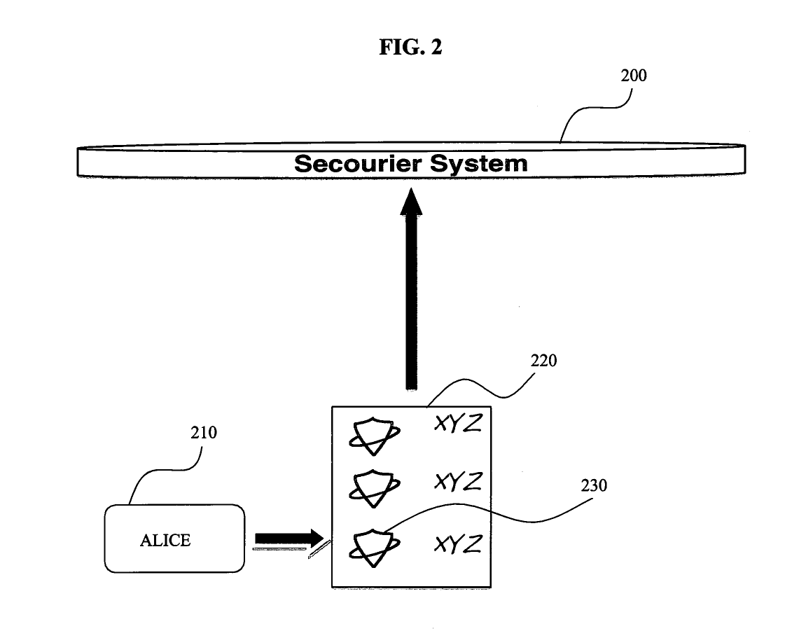

The above-described steps are exemplary, and thus, the present disclosure is not limited thereto. The above steps may be selectively used and other steps may be included. Each of the above steps is discussed in detail with respect to FIGS. 2-7, hereinafter.

FIG. 2 illustrates a method of setting Shields for the data to be protected, according to example embodiments of the present disclosure.

Referring to FIG. 2, the enciphering party (e.g., Alice 210) may communicate with the System 200 to set the conditions upon which a deciphering party (e.g., Bob 130) may gain access to the soon-to-be cipher-protected data prior to transmitting the protected data to Bob 130. These conditions are referred to as Shields.

The deciphering party, for example, Bob 130 could be the enciphering party Alice 210 at a later time. For example, Alice 210 might elect to protect her data on Monday, and then request access to it on Tuesday. Bob 130 could also be a collection of deciphering parties accessing Alice 120's protected data. Both Alice 210 and Bob 130 could be automated computer systems. The generic, traditional names “Alice” and “Bob” and their personification throughout are purely pedagogical and should not be used to limit the scope of the present disclosure in any way.

The conditions upon which a deciphering party may gain access to the ciphered data are referred to as Shields 220. According to an example embodiment, Alice 120 sets the Shields 220, which are then communicated to the System 100, or a centralized system, via the Internet 110. The collection and submission of Shields 220 set by Alice 120 may take place via an HTML web-form, mobile application, portable device, computer, or a website-based interface, however, these are examples, and thus, the present disclosure is not limited thereto. That is, Alice 120 may set Shields 220 using other means which are not discussed herein.

Shields 220 may be the mechanism by which the enciphering party (e.g., Alice 210) communicates with the System 200 to set conditions upon which a deciphering party (e.g., Bob 130) may gain access to the soon-to-be cipher-protected data. There may be three categories of Shields 220, however, these categories are examples, and thus, the present disclosure is not limited thereto. These categories include:

Interactive Shield—An Interactive Shield requires the enciphering party (e.g., Alice 210) to set an input, or verifiable value, to the System 200. An example embodiment of an Interactive Shield is a password.

Structural Shield—A Structural Shield requires the enciphering party (e.g., Alice 210) to set an input, or verifiable value, to the System 200, as well. However, unlike Interactive Shields, Structural Shields do not require the deciphering party (e.g., Bob 130) to provide the input back to the System 200 in order to access the protected data. That is, the input is derived from System 200 values automatically. An example embodiment of a Structural Shield is an expiration date.

Multistage Shield—A Multistage Shield requires the enciphering party (e.g., Alice 210) to set an input, or verifiable value, to the System 200. In addition, another input is required which can either be derived from the System 200—like a Structural Shield, or it can be generated as part and parcel of the deciphering process (e.g. the System 200 sends an email to the email address that was provided by the enciphering party, Alice 210). An example embodiment of a Multistage Shield is an instance where the enciphering party (e.g., Alice 210) sets an email address input, with the System 200, when the deciphering party Bob (e.g., 130) requests access—the System 200 generates and sends Bob 130 an email with a System 200 generated code that Bob 130 must then retrieve and enter.

The above-described Shields may be used individually or may also be combined into Shield Stacks. Further, Table 1 shown below provides several examples of the Interactive Shield, Structural Shield, and the Multistage Shield. However, the Shields of Table 1 are exemplary, and thus, the present disclosure is not limited to the Shields shown in Table 1.

TABLE 1

| Category | Shield | Description |
|---|---|---|
| Interactive | Password | User enters a password |
| Interactive | Key Files | User presents a file(s), the hash of which is used as Shield |
| Interactive | Yubi-Key | User presents a Yubi-key (3^{rd} party integration) as Shield |
| Interactive | E-sign/Contract | A contract is signed . . . |
| Interactive | IP Address | Users IP Address is checked. |
| Interactive | Image/Draw | User is required to draw (draw on) a picture . . . |
| Multistage | Email Code | An email is sent to the user with a code - that code |
| | | completes the Shield |
| Multistage | Postal Mail | A postcard is send to the user with a code - that code |
| | | completes the Shield |
| Multistage | Phone Call | A phone call is places to the user with a code - that code |
| | | completes the Shield |
| Multistage | SMS Code | A text message is sent to user with a code - that code |
| | | completes the Shield |
| Multistage | Cash-on-Delivery (COD) | Payment is prompted for and made. |
| Multistage | Twitter | A direct message is sent to a twitter account |
| Structural | Limited Opens | The number of times a Package can be opened is set, and |
| | | checked. |
| Structural | Time Span | Package can only be opened between x and y. Example - |
| | | package can only be opened between 9 and 5. |
| Structural | Expiration | After a certain time a package cannot be opened. |

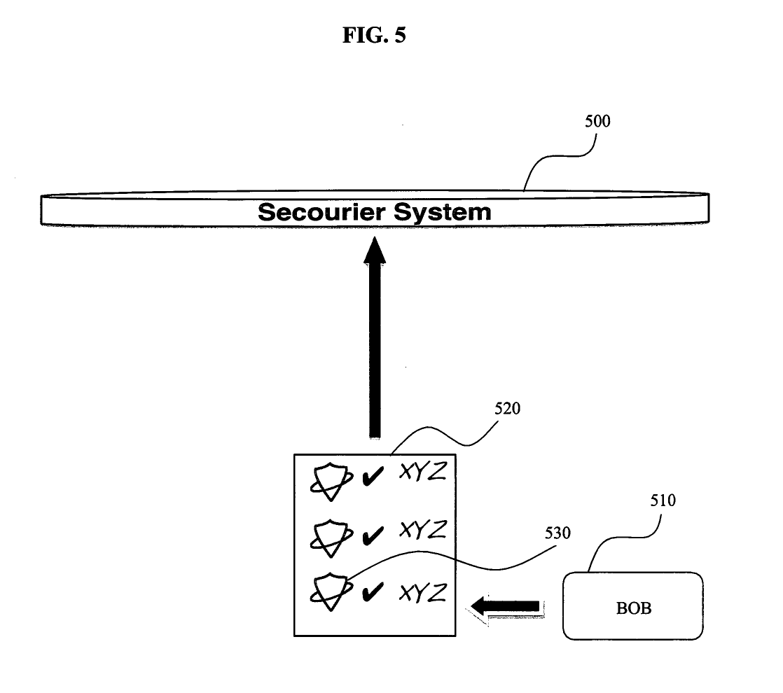

The conditions themselves may be reducible to a form that the System 100 or a centralized system can store, recall, and compare to future data submissions (by the deciphering party, see FIG. 5 below, for example). According to an example embodiment of the present disclosure, the conditions may be any data, which can be stored in digital form, and compared to subsequent data submissions. The Shields 220 could, for example, include a password 230 that Bob 130 would have to communicate to the System 100 in order to gain access to the key needed to decipher the protected data. Shields 220 may also include biometric, geo-locational, or other data transmitted and stored in digital form fit for later comparison, however, the present disclosure is not limited thereto. As can be seen from FIG. 2, the Shields 220 may include one or more conditions set by Alice 210.

Further, these requirements of the Shields 220 may be tailored by a sender (e.g., Alice 210) to meet the sender's needs. For example, a sender can require that a recipient sign a custom digital affidavit or read and acknowledge a simple digital cover letter, agree to receive and open a protected e-mail within a specific timeframe, or even provide a password or other identifying information. The present disclosure may allow for almost any set of Shields 220 imaginable. The above-discussed Shields 220 are exemplary, and thus, the present disclosure is not limited thereto.

While almost anything could serve as the Shields 220, in practicality for Shields 220 to be useful (provide security, auditability, non-repudiation, or other benefits) to Alice 210 and Bob 130, they may effectively limit access to the cipher-protected data. For example, Alice 210 might set a password 230 as one of the Shields 220 (i.e., an Interactive Shield), using a password that only Bob 130 knows, effectively limiting the number of parties that can access the data to two—Alice 320 and Bob 130. As another example embodiment, Alice 120 might set a Shield 220 that requires any deciphering party (Bob 130, for example) be within a certain geographic location. The above embodiments are exemplary, and thus, the present disclosure is not limited thereto.

In another example embodiment, when the System 200 receives the Shields 220 set by Alice 120, the System 200 may “hash” the Shields 220, and store the hash of the Shields 220, instead of the Shield 220 itself because the nature of strong hashing algorithms make reverse engineering the Shields 220 practically impossible. This has the effect of preventing the System 200 or a centralized system from impersonating Bob 130 by providing the Shields 220, while still allowing the System 200 or a centralized system the ability to verify submissions of Shields 220 by those attempting access (Bob 130, for example). According to an example embodiment, the System 200 may use a Cryptographic Hash Function to hash the Shields 220.

In yet another example embodiment, when the System 200 receives the Shields 220 set by Alice 120, it will encipher those Shields 220 with a cipher key (Shield Cipher Key) which is exchanged with Alice 120, and store the resulting cipher text instead of the Shields 220 themselves. In this example embodiment, Alice 120 would include the Shield Cipher Key in the Cipher Package. In this example embodiment, any request to open the Cipher Package (by say, Bob 130) would necessarily include the presentation of the Shield Cipher Key to the System 200 so that the System 200 could decipher the stored cipher text of the Shields 220. By storing the Shields 220 in encrypted form the System 200 mitigates the risk that information in the Shields 220 will be misused, misappropriated, or accessed by those who do not have the Shield Cipher Key, which should only be stored in the Cipher Package.

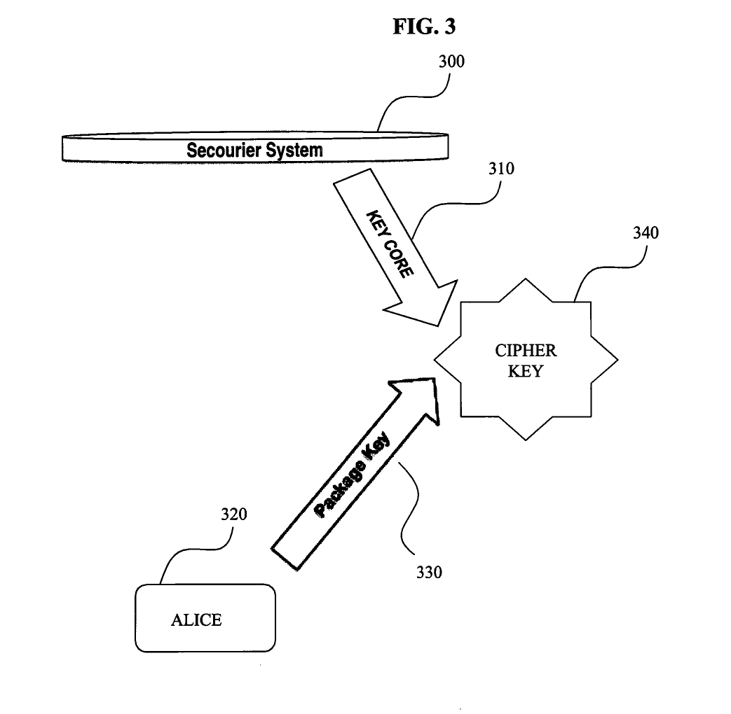

FIG. 3 illustrates a method of generating a Cipher Key, according to example embodiments of the present disclosure.

Referring to FIG. 3, once the Shields 220 are set by Alice 210, as shown in FIG. 2, a Cipher Key 340 may be generated. The Cipher Key 340 that is generated will be used to cipher the data to be protected. One of the core concepts of the System 300 is that the Cipher Key 340 is not shared between Alice 320 and the System 300.

The process for generating the Cipher Key 340 may use (1) a Key Core 310, which is generated and stored by the System 300, and communicated to Alice 320; and (2) a Package Key 330, which is generated by Alice 320, but is not shared with the System 300.

The methods used for generating the Key Core 310 and Package Key 330 may vary, and might be done by a random number generating algorithm or by direct observation of a random natural system. The practical security of the System 300 relies on these values not being guessed by a bad actor attempting wrongful access, so it is imperative that their generation be as close to truly random as possible to prevent bad actors from informing guesses based on an identifiable pattern in the generation of these items. Further, in example embodiments, the System 300 will have access to relatively greater computational resources than Alice 320, making it possible for the System 300 to generate a Key Core 310 which is closer to perfectly random than the Package Key 330 that Alice 320 generates. An elegant by-product of modifying Alice 320's Package Key 330 with the Key Core 310 generated by the System 300 is that the resulting Cipher Key 340 will inherit the improved randomness the System 300's greater computational power affords.

Once Alice 320 has both of these items, i.e., the Key Core 310 and the Package Key 330, she will combine the Package Key 330 and the Key Core 310 to generate a Cipher Key 340. The method of this combination may vary, so long as the following are true: (a) the combination results in a Cipher Key 340 whose calculation is reproducible and requires the input of both the Package Key 330 and the Key Core 310; (b) the combination requires only those values as inputs; and (c) the resulting Cipher Key 340 cannot be derived from either of the Key Core 310 or the Package Key 330 in isolation. According to an example embodiment, the Cipher Key 340 is generating by performing a one-time-pad encryption using the Key Core 310 as the plaintext and the Package Key 330 as the key. In the example embodiment, the Cipher Key 340 is the result of encrypting each bit of the Key Core 340 by calculating the sum of itself and a bit from the Package Key 330, modulo 2 (often referred to as performing an exclusive-or, or “XOR”, operation). The transformation by modular addition and, or, use of one-time-pad encryption is exemplary, and thus, the present disclosure is not limited thereto.

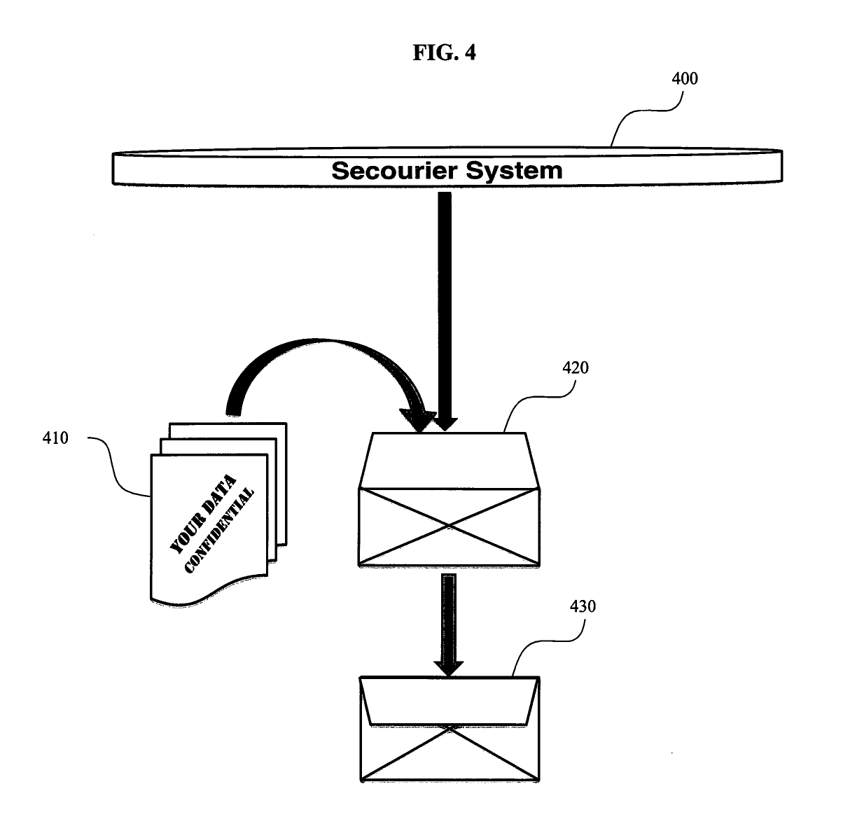

Next, Alice 320 uses the generated Cipher Key 340 to encipher the data to be protected, creating the “Cipher Text”, which is further discussed with respect to FIG. 4. Alice 320 enciphers the data to be protected, using the generated Cipher Key 340, thus ensuring that the System 300 (a) does not know the contents of Alice 320's data, and (b) does not know the Cipher Key 340 used to encrypt the data. Some cipher/encryption algorithms call for multiple inputs instead of a single key. If an encryption algorithm, by its nature, takes two or more inputs, the process for generating the Key can be repeated with a new (additional) Key Core and Package Key to produce a new (additional) “Cipher Key”, or value that can be used as an encryption input. For example, the Advanced Encryption Standard (AES) calls for a “Key”, and an “Initiation Vector”, which are combined during the encryption process. Accordingly, Alice 320 could use the Cipher Key 340 as the AES key, and retrieve a second “Key Core” (or “Initiation Vector Core”), generate a second Package Key, and modify the second Key Core with the second Package Key to produce the Initiation Vector.

In another example embodiment, the method used to modify the Key Core 310 with the Package Key 330 may be known by Bob 130, so that Bob 130 may use these same methods when generating the Cipher Key (See, for example, FIG. 5 below). In this example embodiment, if it is not possible to agree on these methods beforehand, Alice 320 may include information about them in a Cipher Package transmitted to Bob 130.

FIG. 4 illustrates a method of generating and sharing a Cipher Package, according to embodiments of the present disclosure.

Referring to FIG. 4, Alice 410 may generate a Cipher Text 420 of data, which is generated by enciphering the data to be protected using the generated Cipher Key 340. Recall, referring to FIG. 3, the Cipher Key 340 is generated using a Key Core 310 from the System 300 and a Package Key 330 from Alice 320. Next, a Cipher Package 430 may be generated, which may be shared with Bob 130 without fear of eavesdropping, interception, or tampering. The Cipher Package 430 may contain the information that Bob will need to request access to the data from the System 400 and, upon being granted that access, decipher the contents of the package to reveal that data.

According to an example embodiment, the Cipher Package 430 may include the Cipher Text 420; a “Tracking Number”; and the Package Key 330. The Tracking Number is an identifying piece of data generated by the System 400 and communicated to Alice 410. The Tracking Number may be communicated at a later time to the System 400 by Bob 130 and used by the System 400 to recall the conditions (i.e., Shields) set by Alice 410, as discussed above, and the Key Core communicated to Alice 410 that may be stored by the System 400.

Note, these items discussed above, which are included in the Cipher Package 430, are exemplary, and thus, the present disclosure is not limited thereto. That is, these items should be included; however, there are many other items, which Alice 410 may want to include in the Cipher Package 430. For example, dependent on embodiments, these other items might include the modification and combination methods used above with respect to FIG. 3, as well as the cipher technique used to generate the Cipher Text 420, and instructions on how to contact the System 400 to receive the items needed to decipher the data. Inclusion of these additional items would make it possible for Alice 410 to share the Cipher Package 430 with Bob 130 as their first or only communication.

Once assembled, this Cipher Package 430 may be transmitted to Bob 130. The data that Alice 410 transmits may be safe from interceptors and prying eyes because it is contained within the Cipher Text 420, and may only be accessed in accordance with the conditions set, as discussed regarding FIG. 2 above.

According to example embodiments, Alice 410 may receive the Key Core 310 over the Internet from the System 400. Additionally, Alice 410 may use a computer application, for example, to perform the modification necessary to generate the Cipher Key 340 and perform the encryption. This application may run inside a web-browser, as a “web-app” or as an “add-in” or “plug-in” to another application or operating system, or as a stand-alone application, however, the present disclosure is not limited thereto. The present disclosure may provide users like Alice 410 the applications needed to perform all of the steps discussed with reference to FIGS. 2-7. It should be noted that while Alice 410 may use applications provided by the present disclosure, Alice 410 may run those applications on her computer, and not on a System 400 computer, to ensure that the System 400 never has access to the data to be protected, or the Cipher Key 340, Cipher Text 420, Package Key 330, or the Cipher Package 430.

According to example embodiments, the Cipher Package 430 may be a single computer file that may be easily transferred as an attachment to an e-mail, via common file transfer protocols, or in any other manner in which digital files may be shared or transmitted, however, the present disclosure is not limited thereto.

FIG. 5 illustrates a method of requesting access to protected data, according to embodiments of the present disclosure

Referring to FIG. 5, once Bob 510 has received the Cipher Package 430, Bob 510 may request access to the cipher-protected data. Bob 510 may make this request by conveying the Tracking Number included in the Cipher Package 430 to the System 500, and requesting the items needed to decipher the enciphered data.

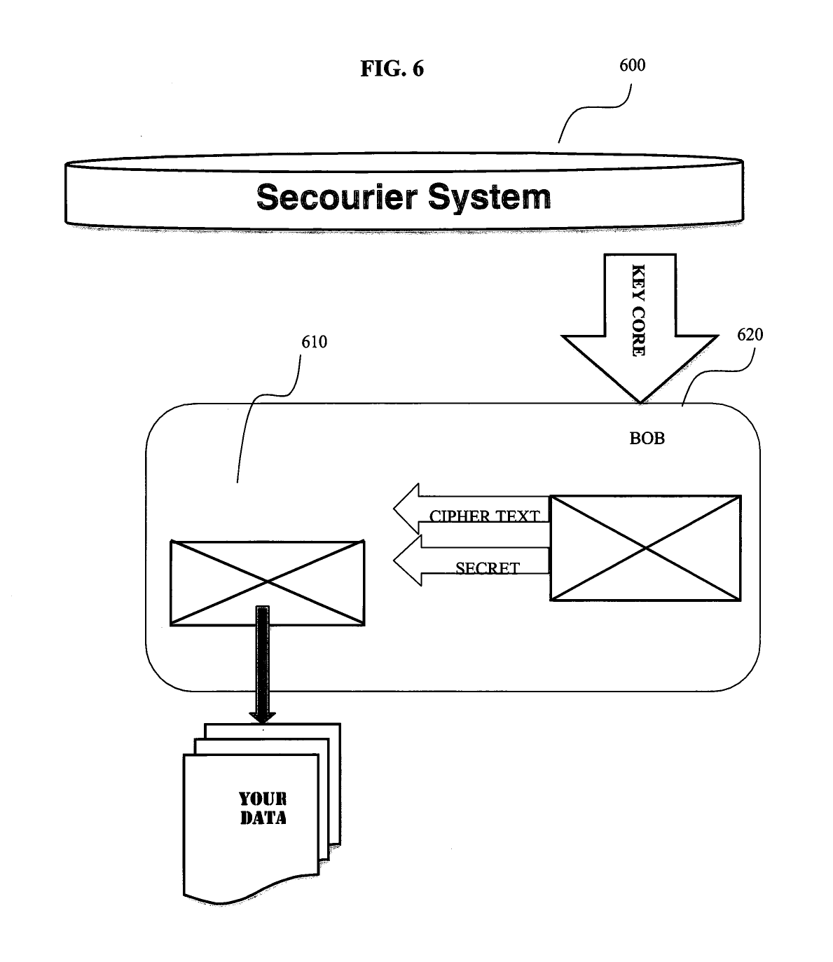

Prior to releasing the items that Bob 510 will need to decipher the data (detailed hereinafter with respect to FIG. 6), Bob 510 must demonstrate to the System 500 that he meets the access conditions (i.e., satisfies all of the Shields 520) that were set by Alice, 410 as discussed above with respect to FIG. 2. For example, the Shields 520 may include a password 530, which is known to Bob 510, and thus, Bob 510 may satisfy the Shields 520 by providing the password 530 to the System 500.

According to example embodiments, the collection and submission of the Shields 520 may take place via an HTML web-form, mobile application, portable device, computer, or a website-based interface, for example, however, the present disclosure is not limited thereto. In another example embodiment, it may also take place as a direct submission of raw data to a web-service, such as uploading data to be protected. Recall from the discussion of FIG. 2 above, that the System 500 may “hash” Bob 510's input, and then compare that input with the hash of Alice 410's input to verify validity.

FIG. 6 illustrates a method of deciphering data, according to embodiments of the present disclosure.

Referring to FIG. 6, after Bob 620 has satisfied the Shields 520 that were set by Alice 410 in order to decipher the data to be protected, the System 600 will release to Bob 620 the Key Core needed to construct the Cipher Key that is used to decipher the data. Recall, the Package Key is part of the Cipher Package 610, so Bob has this already.

For example, Bob 620 receives the Cipher Package 610 and then begins the process of accessing the protected data. When Bob 620 satisfies the Shields 520, Bob 620 then receives the Key Core from the System to decipher the protected data. To generate the Cipher Key, Bob 620 will follow a process very similar to the one Alice 320 used in FIG. 3 above. Accordingly, a discussion about how to generate the Cipher Key by Bob will be omitted. For example, Bob 620 may combine the Key Core and the Package Key received in the Cipher Package 610 to create a Cipher Key using the same method of modification used by Alice 410 described above. Bob 620 then uses the Cipher Key to decipher the data.

Note that Bob 610 performs the decryption of the data using the Cipher Key he generated, thus ensuring that the System (a) does not know the contents of Alice's and Bob's data, and (b) does not know the Cipher Key used to decrypt the data.

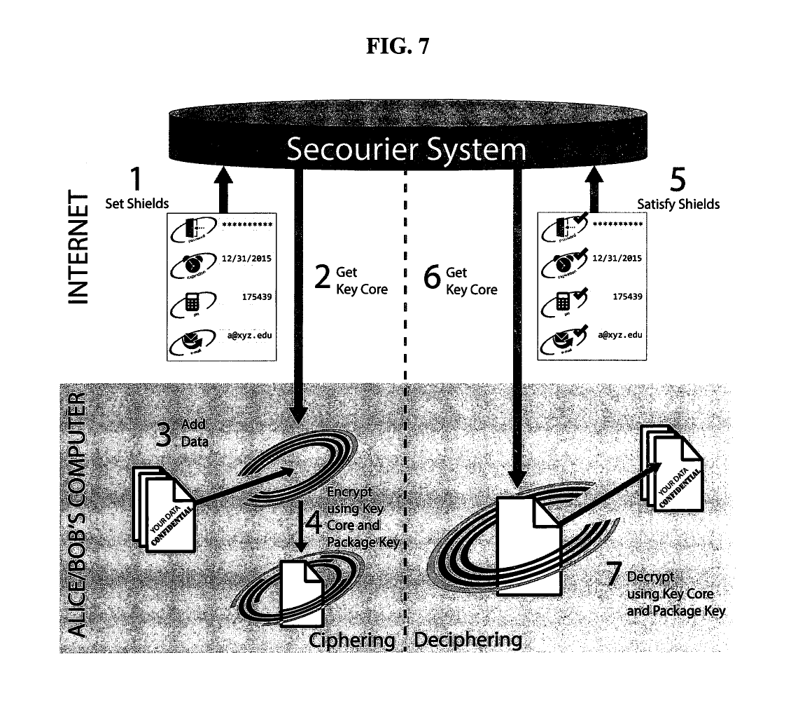

FIG. 7 illustrates a method of protecting data and deciphering the protected data, according to embodiments of the present disclosure.

To accomplish the secure protection of data, the following steps may be performed:
1. The conditions upon which the protected data may be deciphered by the deciphering party may be set by the encrypting party. These conditions may be referred to as Shields;
2. A Key Core is received from the System in order to facilitate the encrypting of the data to be protected;
3. The data to be protected is added by the encrypting party;
4. The data to be protected is encrypted using the Key Core received from the System and a Package Key determined by the encrypting party;
5. The deciphering party receives the encrypted data and satisfies the Shields required to access the encrypted data;
6. The Key Core is received from the System in order to facilitate with the decrypting of the encrypted data; and
7. The deciphering party deciphers the encrypted data using the Key Core received from the System and a Package Key determined by the encrypting party, which is known to the deciphering party.

Throughout the description, it should be understood that Alice 120, Alice 210, Alice 320, and Alice 410 may correspond to the same or different computers or computing environments. It should also be understood that System 100, System 200, System 300, System 400, System 500, and System 600 may correspond to the same or different computers or computing environments. It should also be understood that Bob 130, Bob 510, and Bob 620 may correspond to the same or different computers or computing environments.

Embodiments of the present disclosure are also described above with reference to the accompanying drawings. It will be understood that each drawing, and combinations of drawings, may be implemented by computer program instructions stored on a non-transitory computer readable recording medium. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the drawings.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the drawings. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the methods specified in the FIGS. 1-7.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method for parameter-based key catalyst management, the method comprising:
receiving, from a first terminal, at least one parameter establishing conditions for deciphering data by a second terminal, the at least one parameter being a verifiable value;
transmitting a key catalyst to the first terminal, such that the key catalyst is used in generating a cipher key for enciphering data by the first terminal;
verifying whether the conditions established by the at least one parameter are satisfied by the second terminal; and
releasing the key catalyst to the second terminal only when the established conditions are satisfied by the second terminal, thereby enabling the second terminal to independently generate the cipher key to decipher the enciphered data.

2. The method of claim 1, wherein the cipher key is not shared at any point in time, nor is any information that, in isolation, can be used to decipher the enciphered data communicated between the first and second terminals.

3. The method of claim 1, further comprising: when the first terminal receives the key catalyst, the first terminal generates the cipher key, enciphers the data using the generated cipher key, and transmits the enciphered data to the second terminal without sharing the cipher key.

4. The method of claim 3, wherein the cipher key is generated based on the received key catalyst and a package key.

5. The method of claim 3, further comprising: upon receiving the at least one parameter, the at least one parameter is hashed, and only the hashed parameter is stored, so that the parameter itself is not stored.

6. The method of claim 3, wherein the at least one parameter is received along with a shield cipher key used to encipher the at least one parameter, such that only a resulting cipher text is stored instead of the at least one parameter itself.

7. The method of claim 3, wherein the validating comprises comparing an input received from the second terminal with the verifiable value of the at least one parameter, and releasing the key catalyst to the second terminal only when the input and the verifiable value are identical.

8. The method of claim 3, wherein the validating comprises deriving a value by a server without requiring an input from the second terminal, and releasing the key catalyst to the second terminal only when the value derived by the server satisfies the conditions established by the at least one parameter.

9. The method of claim 8, wherein the at least one parameter is an expiration date.

10. The method of claim 3, wherein, in performing the validating, the first terminal provides an email address of the second terminal, an email containing a system-generated code is transmitted to the email address by a server, and the system-generated code is inputted by the second terminal and verified by the server.

11. The method of claim 3, wherein, in performing the validating, the first terminal provides a phone number of the second terminal, a short message service (SMS) message containing a system-generated code is transmitted to the phone number by a server, and the system-generated code is inputted by the second terminal and verified by the server.

12. The method of claim 3, wherein, in performing the validating, the second terminal receives a system-generated code from a server via a different communication channel, and the system-generated code is inputted by the second terminal for verification by the server.

13. The method of claim 3, wherein the key catalyst is generated by a server, such that the key catalyst is a random value.

14. The method of claim 3, wherein the at least one parameter comprises any combination of interactive shield, structural shield, and multistage shield.

15. The method of claim 13, wherein the data being protected and the enciphered data are not accessible by the server.

16. A method for parameter-based key management, the method comprising:
receiving at least one parameter from a terminal, such that the at least one parameter establishes a condition upon which enciphered data is deciphered;
transmitting a key catalyst to the terminal in response to the received at least one parameter, the key catalyst being used by the terminal to generate a cipher key that enciphers data, and the enciphered data being stored without the cipher key being shared with another terminal;
receiving a request to access the enciphered data from the terminal at a later time, and determining whether the established condition is satisfied by the terminal by comparing an input from the terminal with the at least one parameter; and
releasing the key catalyst to the terminal only when the input from the terminal and the at least one parameter are identical.

17. The method of claim 16, wherein the terminal independently generates the cipher key again based on the received key catalyst and deciphers the stored enciphered data using the cipher key.

18. The method of claim 16, wherein the data to be enciphered is not known to a server and is not stored in the server but only stored in a storage device of the terminal.

19. A system for protecting data, the system comprising:
an enciphering party to protect data to be stored or transmitted by ciphering the data using a cipher key, and establishing conditions upon which that data is to be deciphered by a deciphering party, without requiring the enciphering party or the deciphering party to share the cipher key; without requiring a central server to store the cipher key; and without requiring that the enciphering party share or store private data with the server.

20. The method of claim 13, wherein the server stores information corresponding to each instance that the key catalyst is requested and transmitted, and each instance that the key catalyst is requested and denied.
